(19) United States
(12) Patent Application Publication
(10) Pub. No.: US 2012/0307082 A1
(43) Pub. Date: Dec. 6, 2012

(54) SYSTEM AND METHOD TO ACCOUNT FOR IMAGE LAG DURING CAMERA MOVEMENT

(75) Inventors: Hari Thiruvengada, Plymouth, MN (US); Paul Derby, Lubbock, TX (US); Tom Plocher, Hugo, MN (US); Henry Chen, Beijing (CN)

(73) Assignee: Honeywell International Inc., Morristown, NJ (US)

(21) Appl. No.: 13/153,077

(22) Filed: Jun. 3, 2011

(51) Int. Cl. H04N 5/225

(52) U.S. Cl. 348/207.99; 348/E05.024

(57) ABSTRACT

A system includes a video sensing device, a computer processor coupled to the video sensing device, and a display unit coupled to the computer processor. The system is configured to display on the display unit a live feed of a field of view of the video sensing device, and receive input to modify the field of view of the video sensing device by altering one or more of a pan, a tilt, and a zoom of the video sensing device. After receiving the input to modify the field of view of the video sensing device, the system replaces the live feed on the display unit with alternative video data. The display of the alternative video data occurs during a time period when the pan, tilt, and zoom of the video sensing device is being modified. The system redisplays on the display unit the live feed of the video sensing device after completion of the modification of the pan, tilt and zoom of the video sensing device.

### TECHNICAL FIELD

The present disclosure relates to a system and method to control surveillance cameras, and in an embodiment, but not by way of limitation, a system and method to account for image lag during camera movement.

### BACKGROUND

Due to mechanical movement (e.g., panning or tilting) of surveillance cameras or other video sensing devices, video data that is fed to users may lag behind the user's final pan, tilt, and zoom (PTZ) setting. This problem can become severe when the user quickly changes the PTZ parameters between two values with a relatively large difference. The phenomena can have a great impact on a user who is setting or modifying the PTZ parameters, and can lead to a result that is different from the expectation of the user.

### BRIEF DESCRIPTION OF THE DRAWINGS

FIG. 1 is a block diagram illustrating a lag problem when panning a video sensing device.

FIGS. 2A and 2B are a flow chart of an example embodiment of a process to account for image lag in a video surveillance system.

FIG. 3 is a block diagram of a computer processing system upon which one or more embodiments of the current disclosure can operate.

### DETAILED DESCRIPTION

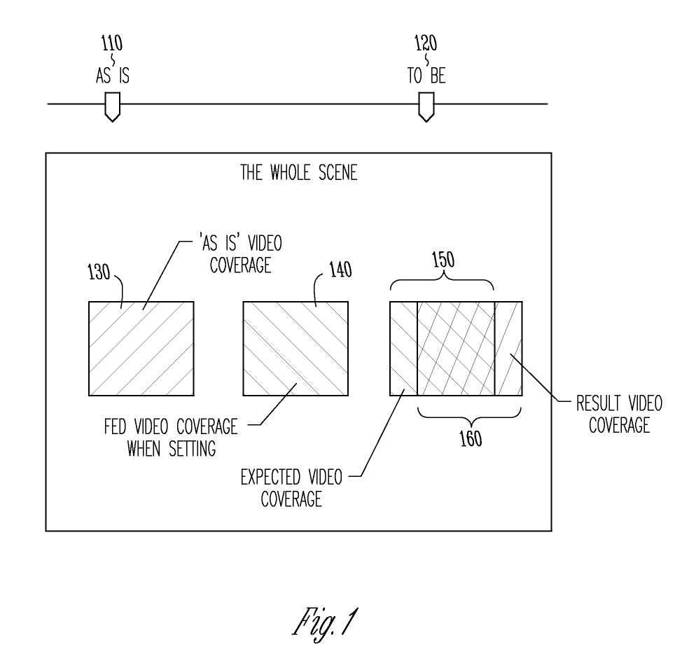

FIG. 1 illustrates a problem that can occur during the panning of a video sensing device. When the user quickly pans the camera from the “As is” position at 110 to the “To be” position at 120, it may take a few seconds to feed video data from area 150 to replace the video data from the area 130. During the pan, the area 140 may be fed to the user. When the user sees video on the area 140, he will be aware that he needs to pan more to right, that is, towards areas 150, 160. Consequently, the area 160 will be fed to the user when the user is done panning. However, the user's expectation was to view area 150, so he must pan to the left again in order to view area 150. In a severe case, a uses can pan back and forth between areas 140, 150, and 160 until he targets in on his desired viewing area.

An embodiment applies computer vision technology to generate panoramic images from alternative video data of a scene, such as one or more snapshots of a camera's video data. When the PTZ parameters are being set, the video window is switched to the image animation from the alternative video data, such as pre-recorded panoramic images, according to these parameters. When camera mechanical movement is finished, the live video feed is reestablished to the camera.

In an embodiment, to get the panoramic image using the alternative video data, a module captures one or more snapshots from the camera video data and stitches them into a panoramic picture. The panoramic image can be generated at camera installation or automatically at periodic intervals after camera installation by applying the snapshot capture module with the valid PTZ parameters. The panoramic image also can be generated or updated at any time when the camera is idle. The panoramic image can also be generated from a stored history of capture snapshots.

To better simulate the real video, multiple panoramic images can be generated and recorded for different environments, such as both day and night, different weather conditions (sunny, cloudy, snowing), different seasons, and different levels of light. The best panorama will be selected according to these values at the time that the captured images are needed.

When a panoramic image is unavailable, a slider button can follow the mechanical movement of a camera. The button also can follow a user's drag, but the state of the camera mechanical movement is displayed correspondingly. When a system has three dimensional capabilities, the current setting can be visualized in the three dimensional scene or image. Snapshots acquired during these methods can be adopted to generate a panoramic image.

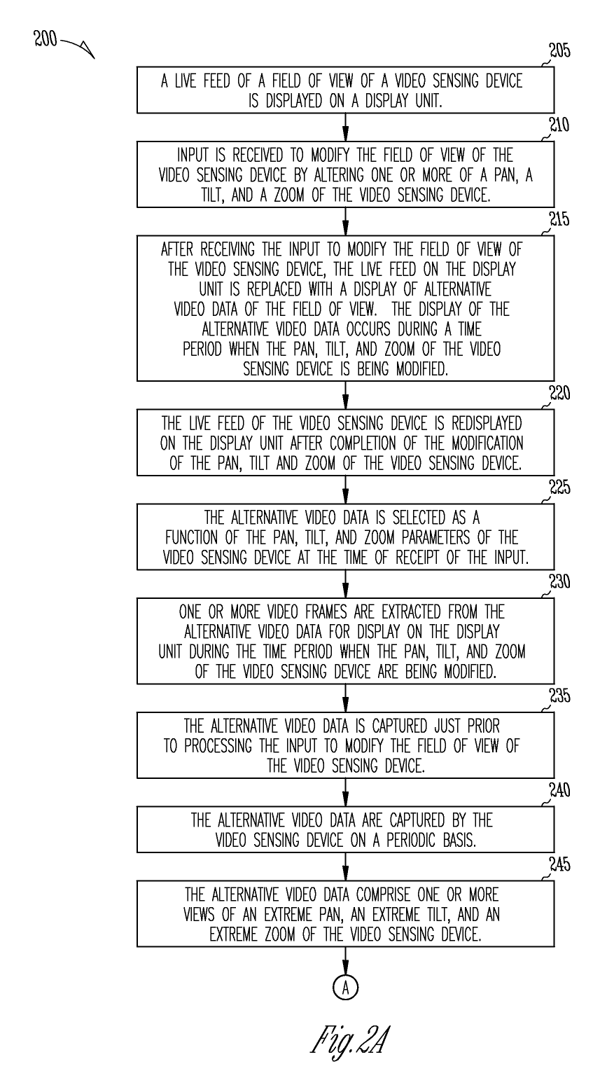

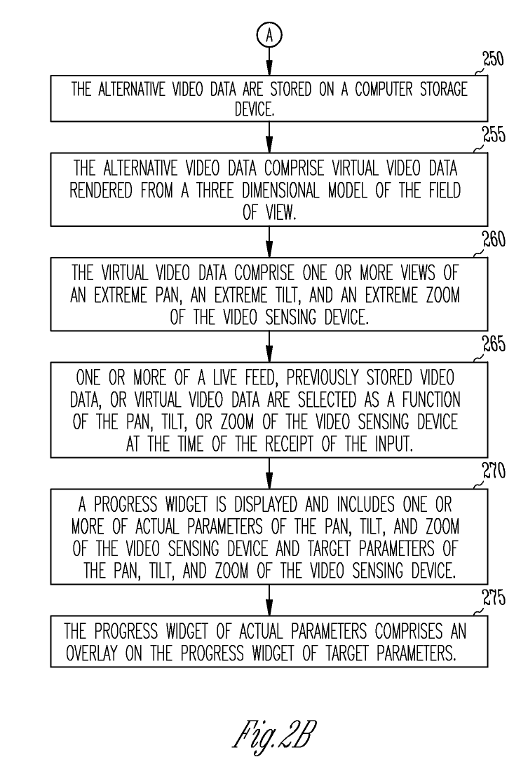

FIGS. 2A and 2B are a flowchart of an example process 200 for accounting for image lag during camera movement. FIGS. 2A and 2B include a number of process blocks 205-275. Though arranged serially in the example of FIGS. 2A and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 2, at 205, a live feed of a field of view of a video sensing device is displayed on a display unit. At 210, input is received to modify the field of view of the video sensing device by altering one or more of a pan, a tilt, and a zoom of the video sensing device. At 215, after receiving the input to modify the field of view of the video sensing device, the live feed on the display unit is replaced with a display of alternative video data of the field of view. The alternative video data can be images of the field of view that have been previously stored. The display of the alternative stored video data occurs during a time period when the pan, tilt, and zoom of the video sensing device is being modified. At 220, the live feed of the video sensing device is redisplayed on the display unit after completion of the modification of the pan, tilt and zoom of the video sensing device.

At 225, the alternative video data are selected as a function of the pan, tilt, and zoom parameters of the video sensing device at the time of receipt of the input. In general, an embodiment considers the field of view at the time that the input is received, considers the targeted field of view (or the extent of the change in the PTZ parameters), and provides the alternative video data based on these considerations so as to provide a smooth transition to the user while panning from one field of view to another. At 230, one or more video frames are extracted from the alternative video data for display on the display unit during the time period when the pan, tilt, and zoom of the video sensing device are being modified. At 235, the alternative video data are captured just prior to processing the input to modify the field of view of the video sensing device. At 240, the alternative video data are captured by the video sensing device on a periodic basis. At 245, the alternative video data comprise one or more views of an extreme pan, an extreme tilt, and an extreme zoom of the video sensing device. At 250, the alternative video data are stored on a computer storage device.

At 255, the alternative video data comprise virtual video data rendered from a three dimensional model of the field of view. At 260, the virtual video data comprise one or more views of an extreme pan, an extreme tilt, and an extreme zoom of the video sensing device. At 265, one or more of a live feed, previously stored video data, or virtual video data are selected as a function of the pan, tilt, or zoom of the video sensing device at the time of the receipt of the input. At 270, a progress widget is displayed and includes one or more of actual parameters of the pan, tilt, and zoom of the video sensing device and target parameters of the pan, tilt, and zoom of the video sensing device. At 275, the progress widget of actual parameters comprises an overlay on the progress widget of target parameters.

### Example Embodiments

Example No. 1 is a system including a video sensing device, a computer processor coupled to the video sensing device, and a display unit coupled to the computer processor. The system is configured to display on the display unit a live feed of a field of view of the video sensing device, receive input to modify the field of view of the video sensing device by altering one or more of a pan, a tilt, and a zoom of the video sensing device, after receiving the input to modify the field of view of the video sensing device, replacing the live feed on the display unit with alternative video data relating to the field of view, the display of the alternative video data occurring during a time period when the pan, tilt, and zoom of the video sensing device is being modified, and redisplay on the display unit the live feed of the video sensing device after completion of the modification of the pan, tilt and zoom of the video sensing device.

Example No. 2 includes the features of Example No. 1 and optionally includes a system wherein the alternative video data comprise previously stored video data of the field of view.

Example No. 3 includes the features of Example Nos. 1-2 and optionally includes a system configured to select the alternative video data as a function of the pan, tilt, and zoom parameters of the video sensing device at the time of receipt of the input.

Example No. 4 includes the features of Example Nos. 1-3 and optionally includes a system configured to extract one or more video frames from the alternative video data for display on the display unit during the time period when the pan, tilt, and zoom of the video sensing device are being modified.

Example No. 5 includes the features of Example Nos. 1-4 and optionally includes a system configured to capture the alternative video data just prior to processing the input to modify the field of view of the video sensing device.

Example No. 6 includes the features of Example Nos. 1-5 and optionally includes a system wherein the alternative video data are captured by the video sensing device on a periodic basis.

Example No. 7 includes the features of Example Nos. 1-6 and optionally includes a system wherein the alternative video data comprise one or more views of an extreme pan, an extreme tilt, and an extreme zoom of the video sensing device.

Example No. 8 includes the features of Example Nos. 1-7 and optionally includes a system wherein the alternative video data are stored on a computer storage device.

Example No. 9 includes the features of Example Nos. 1-8 and optionally includes a system wherein the alternative video data comprise virtual video data rendered from a three dimensional model of the field of view.

Example No. 10 includes the features of Example Nos. 1-9 and optionally includes a system wherein the virtual video data comprise one or more views of an extreme pan, an extreme tilt, and an extreme zoom of the video sensing device.

Example No. 11 includes the features of Example Nos. 1-10 and optionally includes a system configured to select one or more of the live feed, previously stored video data, or virtual video data as a function of the pan, tilt, or zoom of the video sensing device at the time of the receipt of the input.

Example No. 12 includes the features of Example Nos. 1-11 and optionally includes a system configured to display via a progress widget one or more of actual parameters of the pan, tilt, and zoom of the video sensing device and target parameters of the pan, tilt, and zoom of the video sensing device.

Example No. 13 includes the features of Example Nos. 1-12 and optionally includes a system wherein the progress widget of actual parameters comprises an overlay on the progress widget of target parameters.

Example No. 14 is a computer-readable medium comprising instructions that when executed by a processor executes a process comprising displaying on a display unit a live feed of a field of view of a video sensing device, receiving input to modify the field of view of the video sensing device by altering one or more of a pan, a tilt, and a zoom of the video sensing device, after receiving the input to modify the field of view of the video sensing device, replacing the live feed on the display unit with alternative video data relating to the field of view, the display of the alternative video data occurring during a time period when the pan, tilt, and zoom of the video sensing device is being modified, and redisplaying on the display unit the live feed of the video sensing device after completion of the modification of the pan, tilt and zoom of the video sensing device.

Example No. 15 includes the features of Example No. 16 and optionally includes instruction for selecting the alternative video data as a function of the pan, tilt, and zoom parameters of the video sensing device at the time of receipt of the input.

Example No. 16 includes the features of Example Nos. 14-15 and optionally includes instructions such that the alternative video data comprise virtual video data rendered from a three dimensional model of the field of view.

Example No. 17 includes the features of Example Nos. 14-16 and optionally includes instructions for displaying via a progress widget one or more of actual parameters of the pan, tilt, and zoom of the video sensing device and target parameters of the pan, tilt, and zoom of the video sensing device.

Example No. 18 is a method including displaying on a display unit a live feed of a field of view of a video sensing device, receiving input to modify the field of view of the video sensing device by altering one or more of a pan, a tilt, and a zoom of the video sensing device, after receiving the input to modify the field of view of the video sensing device, replacing the live feed on the display unit with alternative video data relating to the field of view, the display of the alternative video data occurring during a time period when the pan, tilt, and zoom of the video sensing device is being modified, and redisplaying on the display unit the live feed of the video sensing device after completion of the modification of the pan, tilt and zoom of the video sensing device.

Example No. 19 includes the features of Example No. 18 and optionally includes selecting the alternative video data as a function of the pan, tilt, and zoom parameters of the video sensing device at the time of receipt of the input, and displaying via a progress widget one or more of actual parameters of the pan, tilt, and zoom of the video sensing device and target parameters of the pan, tilt, and zoom of the video sensing device.

Example No. 20 includes the features of Example Nos. 18-19 and optionally includes a process wherein the alternative video data comprise virtual video data rendered from a three dimensional model of the field of view.

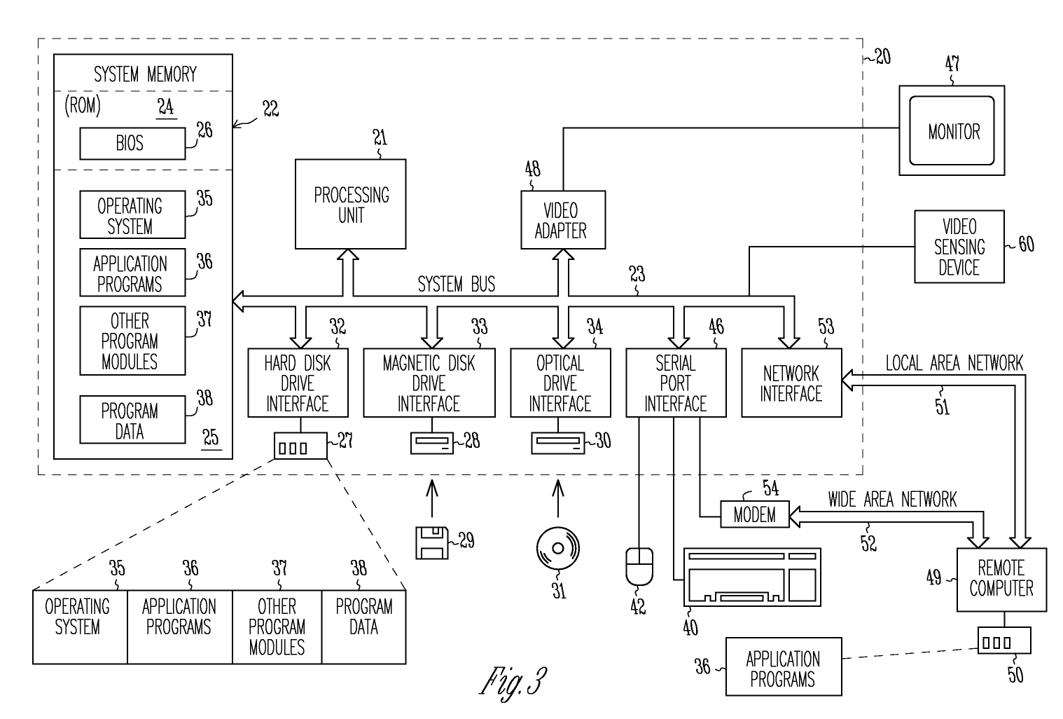

FIG. 3 is an overview diagram of a hardware and operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Video sensing device 60 is coupled to the processing unit 21 via system bus 23, and coupled to the monitor 47 via the system bus 23 and the video adapter 48.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a video sensing device;
a computer processor coupled to the video sensing device; and
a display unit coupled to the computer processor;
wherein the system is configured to:
display on the display unit a live feed of a field of view of the video sensing device;
receive input to modify the field of view of the video sensing device by altering one or more of a pan, a tilt, and a zoom of the video sensing device;
after receiving the input to modify the field of view of the video sensing device, replacing the live feed on the display unit with alternative video data relating to the field of view, the display of the alternative video data occurring during a time period when the pan, tilt, and zoom of the video sensing device is being modified; and
redisplay on the display unit the live feed of the video sensing device after completion of the modification of the pan, tilt and zoom of the video sensing device.

2. The system of claim 1, wherein the alternative video data comprise previously stored video data of the field of view.

3. The system of claim 1, configured to select the alternative video data as a function of the pan, tilt, and zoom parameters of the video sensing device at the time of receipt of the input.

4. The system of claim 1, configured to extract one or more video frames from the alternative video data for display on the display unit during the time period when the pan, tilt, and zoom of the video sensing device are being modified.

5. The system of claim 1, configured to capture the alternative video data just prior to processing the input to modify the field of view of the video sensing device.

6. The system of claim 1, wherein the alternative video data are captured by the video sensing device on a periodic basis.

7. The system of claim 1, wherein the alternative video data comprise one or more views of an extreme pan, an extreme tilt, and an extreme zoom of the video sensing device.

8. The system of claim 1, wherein the alternative video data are stored on a computer storage device.

9. The system of claim 1, wherein the alternative video data comprise virtual video data rendered from a three dimensional model of the field of view.

10. The system of claim 9, wherein the virtual video data comprise one or more views of an extreme pan, an extreme tilt, and an extreme zoom of the video sensing device.

11. The system of claim 1, configured to select one or more of the live feed, previously stored video data, or virtual video data as a function of the pan, tilt, or zoom of the video sensing device at the time of the receipt of the input.

12. The system of claim 1, configured to display via a progress widget one or more of actual parameters of the pan, tilt, and zoom of the video sensing device and target parameters of the pan, tilt, and zoom of the video sensing device.

13. The system of claim 12, wherein the progress widget of actual parameters comprises an overlay on the progress widget of target parameters.

14. A computer-readable medium comprising instructions that when executed by a processor executes a process comprising:
displaying on a display unit a live feed of a field of view of a video sensing device;
receiving input to modify the field of view of the video sensing device by altering one or more of a pan, a tilt, and a zoom of the video sensing device;
after receiving the input to modify the field of view of the video sensing device, replacing the live feed on the display unit with alternative video data relating to the field of view, the display of the alternative video data occurring during a time period when the pan, tilt, and zoom of the video sensing device is being modified; and
redisplaying on the display unit the live feed of the video sensing device after completion of the modification of the pan, tilt and zoom of the video sensing device.

15. The computer-readable medium of claim 14, comprising instructions for selecting the alternative video data as a function of the pan, tilt, and zoom parameters of the video sensing device at the time of receipt of the input.

16. The computer-readable medium of claim 14, wherein the alternative video data comprise virtual video data rendered from a three dimensional model of the field of view.

17. The computer-readable medium of claim 14, comprising instructions for displaying via a progress widget one or more of actual parameters of the pan, tilt, and zoom of the video sensing device and target parameters of the pan, tilt, and zoom of the video sensing device.

18. A method comprising:
displaying on a display unit a live feed of a field of view of a video sensing device;
receiving input to modify the field of view of the video sensing device by altering one or more of a pan, a tilt, and a zoom of the video sensing device;
after receiving the input to modify the field of view of the video sensing device, replacing the live feed on the display unit with alternative video data relating to the field of view, the display of the alternative video data occurring during a time period when the pan, tilt, and zoom of the video sensing device is being modified; and
redisplaying on the display unit the live feed of the video sensing device after completion of the modification of the pan, tilt and zoom of the video sensing device.

19. The method of claim 18, comprising:
selecting the alternative video data as a function of the pan, tilt, and zoom parameters of the video sensing device at the time of receipt of the input; and
displaying via a progress widget one or more of actual parameters of the pan, tilt, and zoom of the video sensing device and target parameters of the pan, tilt, and zoom of the video sensing device.

20. The method of claim 18, wherein the alternative video data comprise virtual video data rendered from a three dimensional model of the field of view.
